(19) United States
(12) Patent Application Publication
(10) Pub. No.: US 2008/0268310 A1
(43) Pub. Date: Oct. 30, 2008

(54) Hydrogen generating apparatus and fuel cell system using the same

(75) Inventors: Bosung Ku, Suwon-si (KR); Jae-Hyuk Jang, Seongnam-si (KR); Jae-Hyoung Gil, Seoul (KR); Chang-Ryul Jung, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD, Suwon (KR)

(21) Appl. No.: 11/812,521

(22) Filed: Jun. 19, 2007

(30) Foreign Application Priority Data
Apr. 26, 2007 (KR) 10-2007-0040747

(51) Int. Cl. H01M 8/18

(52) U.S. Cl. 429/21

(57) ABSTRACT

The hydrogen generating apparatus of the present invention includes an electrolyzer filled with an aqueous electrolyte solution containing ammonium chloride; a first metal electrode that is disposed in the electrolyzer, is immersed in the aqueous electrolyte solution, and generates electrons; and a second metal electrode that is disposed in the electrolyzer, is immersed in the aqueous electrolyte solution, and generates hydrogen gas by receiving the electrons. The hydrogen generating apparatus according to the present invention can increase hydrogen generation time and an amount of hydrogen generation.

### CROSS-REFERENCE TO RELATED APPLICATION

This application claims the benefit of Korean Patent Application No. 10-2007-0040747 filed with the Korean Intellectual Property Office on Apr. 26, 2007, the disclosures of which are incorporated herein by reference in its entirety.

### BACKGROUND OF THE INVENTION

1. Technical Field

The present invention relates to a hydrogen generating apparatus, more particularly to a hydrogen generating apparatus including an aqueous electrolyte solution that contains ammonium chloride (NH₄Cl).

2. Description of the Related Art

A fuel cell refers to an energy conversion apparatus that directly converts oxygen in the air and hydrogen contained in hydrocarbons such as methanol or natural gas into electrical energy by an electrochemical reaction.

FIG. 1 illustrates the basic operational principle of a fuel cell. Referring to FIG. 1, a fuel cell 10 may include a fuel electrode 11 as an anode and an air electrode 13 as a cathode. The fuel electrode 11 receives molecular hydrogen (H₂). The hydrogen is dissociated at the fuel electrode to form hydrogen ions (H⁺) and electrons (e⁻).

The hydrogen ions (H⁺) move toward the air electrode 13 via a membrane 12 which is an electrolyte layer. The electrons move through an external circuit 14 to generate an electric current. The hydrogen ions and the electrons are combined with oxygen of the air at the air electrode 13 to generate water. The fuel electrode 11 and the air electrode 13 are disposed in between the electrolyte membrane to form a membrane electrode assembly (MEA).

The following Reaction Scheme 1 explains the above mentioned chemical reactions:

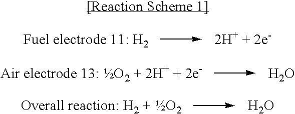

In short, the fuel cell 10 functions as a battery since the electrons dissociated from the fuel electrode 11 generate current, moving through the external circuit. Such a fuel cell 10 not only is a pollution-free power because it has no noxious emissions such as SOx, NOx, etc., but also produces a small amount of carbon dioxide. Also, the fuel cell device has some advantages, such as low noise and vibration-free and so on.

Fuel cells may be classified, depending on the electrolyte being used, as follows: alkaline fuel cells (AFC); phosphoric acid fuel cells (PAFC); molten carbonate fuel cells (MCFC); and polymer electrolyte membrane fuel cells (PEMFC). Among them, the polymer electrolyte membrane fuel cells can be further classified into proton exchange membrane fuel cells (PEMFC) in which hydrogen gas is directly used as a fuel; and direct methanol fuel cells (DMFC) in which the liquid methanol is directly used as a fuel.

The polymer electrolyte membrane fuel cells can be smaller in size and lighter in weight because of their low operating temperature and high power density, compared to other fuel cells. For these reasons, the polymer electrolyte membrane fuel cells are particularly suitable for use in transportable power supply equipments for vehicles including cars; on-site power supply equipments for in-house or public facilities; and small size power supply units for electronic appliances. Therefore, a great deal of development research is currently under way on the polymer electrolyte membrane fuel cell technologies.

Meanwhile, stable hydrogen production and supply thereof is the most challenging technical problem to be solved so as to commercialize the fuel cells. A hydrogen storage tank, generally known as the hydrogen generating apparatus, has been used to solve these problems. However, the tank apparatus occupies a large space and should be kept with special care.

In order to avoid such drawbacks associated with the known apparatus, fuels such as methanol and formic acid permitted to be brought into an airplane by International Civil Aviation Organization (ICAO) are reformatted into hydrogen: or methanol, ethanol, or formic acid is directly used as a fuel in the fuel cell.

However, the former case requires a high reform temperature and a complicate system, consumes driving power, and contains impurities (CO₂, CO) besides pure hydrogen molecules. The latter case deteriorates power density due to a low rate of a chemical reaction at the anode and a cross-over of hydrocarbon through the membrane.

Besides, hydrogen generating methods for PEMFC are as follows: oxidation of aluminium, hydrolysis of metal borohydride and reaction on a metal electrode and so on. Among them, the preferable method for efficiently controlling a generation rate of hydrogen is by using the metal electrode.

However, a metal hydroxide is produced as a by-product when the reaction on the metal electrode is carried out continuously. The metal hydroxide exists in a slurry state in a reactor due to its low water solubility, which may result in deterioration of hydrogen generation efficiency.

Accordingly, the present inventors have researched to overcome the above-described problems. As a result, the present inventors develop a new hydrogen generating apparatus which is capable of generating hydrogen at high efficiency at room temperature.

### SUMMARY

The present invention provides a hydrogen generating apparatus including an electrolyzer filled with an aqueous electrolyte solution that contains ammonium chloride; a first metal electrode that is disposed in the electrolyzer, is immersed in the aqueous electrolyte solution, and generates electrons; and a second metal electrode that is disposed in the electrolyzer, is immersed in the aqueous electrolyte solution, and generates hydrogen gas by receiving the electrons.

The ammonium chloride in the aqueous electrolyte solution has a concentration ranging from about 0.05 M to about 2 M.

The hydrogen generating apparatus can be combined with a fuel cell to supply hydrogen to the fuel cell.

At least two of each of the first metal electrode and the second metal electrode can be disposed in the electrolyzer.

Further, the present invention can provide a fuel cell system including the hydrogen generating apparatus according to the invention; and a membrane electrode assembly (MEA) that is provided with hydrogen generated from the hydrogen generating apparatus and produces direct electric current by converting a chemical energy of the hydrogen into an electric energy.

These and other features, aspects, and advantages of the present invention will become better understood with regard to the following description, appended claims, and accompanying drawings or may be learned by practice of the invention.

### BRIEF DESCRIPTION OF THE DRAWINGS

FIG. 1 illustrates the basic operational principle of a fuel cell.

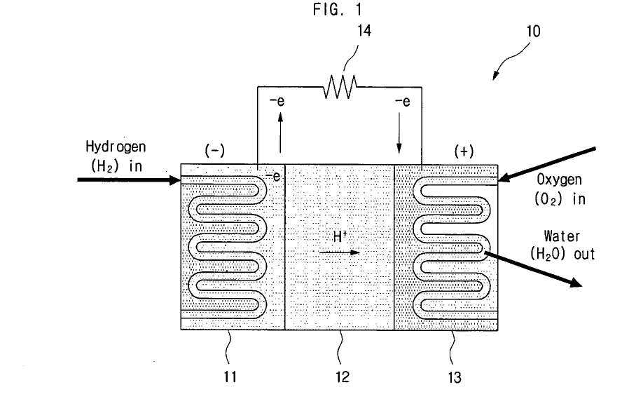

FIG. 2 is a sectional view of a hydrogen generating apparatus according to an example of the present invention.

FIG. 3 is a graph showing an amount of hydrogen generated from each apparatus according to an example and a comparative example of the present invention.

### DETAILED DESCRIPTION

The present invention provides a hydrogen generating apparatus in a fuel cell system which increases time and amount of hydrogen generation by adding ammonium chloride (NH₄Cl) into an aqueous electrolyte solution to increase water solubility of metal hydroxide that is produced as a by-product when the aqueous electrolyte solution is electrolysised to generate hydrogen.

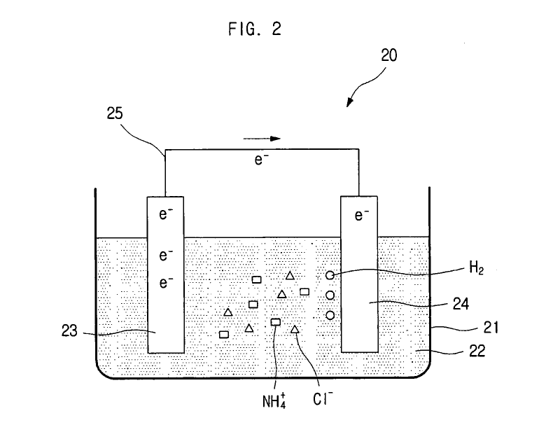

FIG. 2 is a sectional view of a hydrogen generating apparatus according to an example of the present invention. The hydrogen generating apparatus 20 of the present invention includes an electrolyzer 21, a first electrode 23, and a second electrode 24.

The description below focuses on an exemplary case where the first electrode 23 is composed of magnesium (Mg) and the second electrode 24 is composed of stainless steel.

Referring back to FIG. 2, the electrolyzer 21 is filled with an electrolyte solution 22. The electrolyzer 21 can include the first electrode 23 and the second electrode 24, which may be immersed in the electrolyte solution entirely or partly.

The first electrode 23 is an active electrode, where the magnesium (Mg) is oxidized into a magnesium ion (Mg²⁺) releasing two electrons, due to the difference of ionization energy between the magnesium and the water (H₂O). The resulting electrons move to the second electrode 24 through an electric wire 25.

The second electrode 24 is an inactive electrode, where the water molecules receive the electrons moved from the first electrode 23 and is decomposed into hydrogen molecules.

The following Reaction Scheme 2, explains the above mentioned chemical reactions:

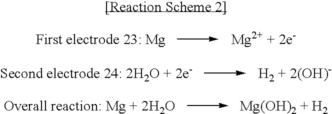

As a result of the Reaction Scheme 2, the magnesium hydroxide (Mg(OH)₂) is produced of which water solubility is no more than about 12 mg/L. So, the magnesium hydroxide exists in a slurry state in the electrolyzer when the reaction is carried out continuously. The magnesium hydroxide slurry inhibits water movement, which may result in deterioration of efficient hydrogen generation.

The present invention provides an addition of ammonium chloride (NH₄Cl) into the aqueous electrolyte solution, which increases water solubility of the metal hydroxide. The magnesium hydroxide reacts with the ammonium chloride so that its water solubility is increased up to about 167 g/L. The following Reaction Scheme 3 explains the above mentioned chemical reactions:

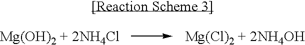

The Reaction Scheme 3 shows that 2 moles of ammonium chloride is needed to react with 1 mol of magnesium hydroxide. Therefore, an amount of the ammonium chloride used for the hydrogen generating apparatus of the present invention may be 2 moles or less based on 1 mole of magnesium hydroxide. Particularly, a concentration of ammonium chloride in accordance with the invention may range from about 0.05 M to about 2 M. If the concentration of ammonium chloride is less than 0.05 M, the ammonium chloride hardly affects the solubility of magnesium hydroxide in water. On the other hand, if the concentration of ammonium chloride exceeds 2 M, the hydrogen generation rate can be deteriorated inefficiently.

In the aqueous electrolyte solution 22, an electrolyte including, but not limited to, LiCl; KCl; NaCl; K₂SO₄; or Na₂SO₄, etc, can be used. Among them, KCl may be more preferably used.

In an embodiment of the present invention, the first electrode 23 can be composed of a metal with relatively higher ionization tendency such as iron (Fe) or an alkali metal such as aluminium (Al), zinc (Zn), etc, besides the magnesium. And, the second electrode 24 can be composed of a metal with relatively lower ionization tendency compared to the first electrode 23 such as platinum (Pt), copper (Cu), gold (Au), silver (Ag), iron (Fe), etc, besides the stainless steel.

The hydrogen generating apparatus of the present invention may include at least 2 of the first electrode 23 and/or the second electrode 24 independently. As the numbers of the first electrode 23 and/or the second electrode 24 are increased, the amount of the hydrogen generated during the same time becomes larger so that it can take a shorter time to generate the hydrogen as much as demanded.

The hydrogen generating apparatus can be combined with a fuel cell to supply hydrogen to the fuel cell. The fuel cell of the invention is, but not limited to, a polymer membrane fuel cell such as the polymer electrolyte membrane fuel cell.

Also, the hydrogen generating apparatus according to the invention can be used in a fuel cell system including a membrane electrode assembly (MEA) that is provided with hydrogen generated from the hydrogen generating apparatus and produces direct electric current by converting a chemical energy of the hydrogen into an electric energy.

The invention may be better understood by reference to the following examples which are intended for the purpose of illustration and are not to be construed as in any way limiting the scope of the present invention, which is defined in the claims appended hereto.

### EXAMPLE

The hydrogen generation apparatus according to this invention was prepared as below:

First electrode 23: 3 g of Magnesium (Mg)

Second electrode 24: Stainless steel

Distance between the electrodes: 3 mm

Kind and concentration of electrolyte: 30 wt. % of KCl

Mass of ammonium chloride: 0.5 g

Number of used electrodes: 3 Magnesium electrodes, 3 Stainless steel electrodes

Electrode connecting method: Serial connection

Volume of aqueous electrolyte solution: 60 cc

Size of an electrode: 24 mm×85 mm×1 mm,

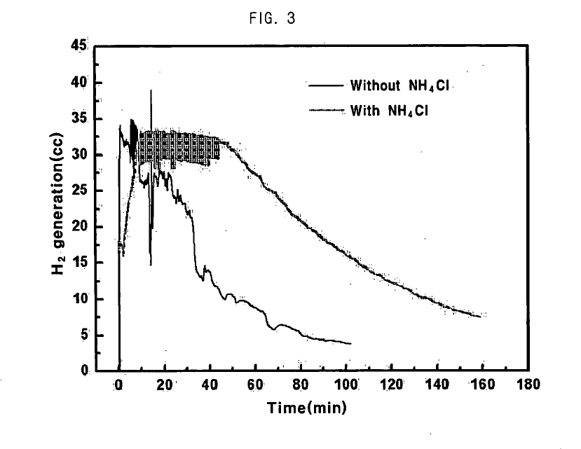

and the electrochemical reaction was accomplished using the apparatus. Then, the resulting amount of hydrogen generation was measured by a mass flow meter (MFM). The result is shown in FIG. 3.

### COMPARATIVE EXAMPLE

Comparative Example was conducted in the same manner as in Example 1 except that 0.5 g of ammonium chloride was not used. The resulting amount of hydrogen generation is shown in FIG. 3.

As shown in FIG. 3, it is noted that when the ammonium chloride was added in the aqueous electrolyte solution as in Example, time and amount of the hydrogen generation was increased, compared with the Comparative Example in which ammonium chloride was not added.

The present invention can be easily carried out by an ordinary skilled person in the art. Many modifications and changes may be deemed to be with the scope of the present invention as defined in the following claims.

What is claimed is:

1. A hydrogen generating apparatus comprising:
an electrolyzer filled with an aqueous electrolyte solution comprising ammonium chloride;
a first metal electrode that is disposed in the electrolyzer, is immersed in the aqueous electrolyte solution, and generates electrons; and
a second metal electrode that is disposed in the electrolyzer, is immersed in the aqueous electrolyte solution, and generates hydrogen gas by receiving the electrons.

2. The hydrogen generating apparatus according to claim 1, wherein the ammonium chloride in the aqueous electrolyte solution has a concentration ranging from about 0.05 M to about 2 M.

3. The hydrogen generating apparatus according to claim 1, wherein the first metal electrode comprises magnesium.

4. The hydrogen generating apparatus of claim 1, wherein the hydrogen generating apparatus is combined with a fuel cell to supply hydrogen to the fuel cell.

5. The hydrogen generating apparatus of claim 1, wherein at least two of each of the first metal electrode and the second metal electrode are disposed in the electrolyzer.

6. A fuel cell system comprising:
a hydrogen generating apparatus as defined in claim 1; and
a membrane electrode assembly (MEA) that is provided with hydrogen generated from the hydrogen generating apparatus and produces direct electric current by converting a chemical energy of the hydrogen into an electric energy.
